(19) United States
(12) Patent Application Publication
(10) Pub. No.: US 2024/0037555 A1
(43) Pub. Date: Feb. 1, 2024

(54) PAYMENT OWNERSHIP VALIDATION

(71) Applicant: Wells Fargo Bank, N.A., San Francisco, CA (US)

(72) Inventors: Daniel Cusick, San Francisco, CA (US); Alan W. Hecht, San Francisco, CA (US); Ann M. Kirk, Deerwood, MN (US)

(21) Appl. No.: 16/712,632

(22) Filed: Dec. 12, 2019

Related U.S. Application Data
(62) Division of application No. 16/017,354, filed on Jun. 25, 2018.
(60) Provisional application No. 62/525,624, filed on Jun. 27, 2017.

(51) Int. Cl. G06Q 20/40; G06Q 20/42; H04W 12/06; H04L 29/06; G06Q 20/02

(52) U.S. Cl. CPC G06Q 20/4014; G06Q 20/42; H04W 12/06; H04L 63/08; G06Q 20/023

(57) ABSTRACT

A financial institution computing system includes a network circuit enabling exchanging information over a network, a customer database storing financial information and validated customer information for a plurality of customers of the financial institution, and a transaction authentication circuit configured to receive transaction information from an originating computing device; determine that the transaction is one of an on-us transaction or an off-us transaction; authenticate the transaction information, in response to the transaction being off-us, by determining that the transaction information matches information stored in a third party authentication system; authenticate the transaction information by determining, in response to the transaction being on-us, that the transaction information matches the validated customer information stored in the customer database; and transmit a confirmation message to the originating computing device.

### CROSS-REFERENCE TO RELATED APPLICATIONS

The application is a divisional of U.S. patent application Ser. No. 16/017,354, filed Jun. 25, 2018, which claims priority to and benefit of U.S. Provisional Patent Application No. 62/525,624, filed Jun. 27, 2017, both of which are incorporated herein by reference in their entireties.

### BACKGROUND

The Automated Clearing House (“ACH”) network is a computer-based clearing and settlement network for exchanging electronic transactions between participating financial institutions. The ACH network processes large volumes of credit and debit transactions in batches. ACH credit transfers typically include direct deposit, payroll, and vendor payments. ACH direct debit transfers typically include consumer payments of various types of bills or purchases, such as automatic bill payments and purchases made online or over the phone. Current ACH transaction authentication systems process transaction requests based at least in part on whether a routing transit number and an account number included in the transaction request match a verified routing transit number and a verified account number held at a financial institution. Fraudsters are sometimes able to exploit accounts held at financial institutions if they are able to obtain a valid routing transit number and a valid account number for the account. Oftentimes, fraudsters do not have complete account information for the accounts upon which they are trying to perpetrate fraud.

### SUMMARY

One exemplary embodiment relates to a financial institution computing system. The system includes a network circuit configured to enable the financial institution computing system to exchange information over a network, a customer database configured to store financial information and validated customer information for a plurality of customers of the financial institution, and a transaction authentication circuit. The transaction authentication circuit is configured to receive, over the network circuit, transaction information from an originating computing device, the transaction information including information indicative of an account number, a name, and a routing transit number. The circuit is further configured to determine that the transaction information is for an Automated Clearing House type transaction, wherein the financial institution computing system serves as both an Originating Depository Financial Institution and a Receiving Depository Financial Institution. The circuit is further configured to determine that the transaction is an off-us transaction; determine whether the transaction information matches the validated customer information stored in the customer database by comparing the transaction information to the validated customer information. The circuit is further configured to authenticate the transaction information based on the transaction information matching the validated customer information.

Another exemplary embodiment relates to financial institution computing system. The system includes a network circuit configured to enable the financial institution computing system to exchange information over a network, a customer database configured to store financial information and validated customer information for a plurality of customers of the financial institution, and a transaction authentication circuit. The circuit is further configured to receive, over the network circuit, transaction information from an originating computing device, the transaction information including information indicative of an account number, a name, and a routing transit number. The circuit is further configured to determine that the transaction information is for an Automated Clearing House type transaction, wherein the financial institution computing system serves as both an Originating Depository Financial Institution and a Receiving Depository Financial Institution. The circuit is further configured to determine that the transaction is an on-us transaction. The circuit is further configured to determine whether the transaction information matches the validated customer information stored in the customer database by comparing the transaction information to the validated customer information. The circuit is further configured to prompt, in response to the transaction information not matching the validated customer information, an authorized account owner to conform that a transaction associated with the transaction information was authorized. The circuit is further configured to authenticate the transaction information based on the transaction information matching the validated customer information or based on the authorized account owner confirming that the transaction was authorized.

Another exemplary embodiment relates to a financial institution computing system. The system includes a network circuit configured to enable the financial institution computing system to exchange information over a network, a customer database configured to store financial information and validated customer information for a plurality of customers of the financial institution, and a transaction authentication circuit. The circuit is configured to receive, over the network via the network circuit, transaction information from an originating computing device, the transaction information including information indicative of an account number, a name, and a routing transit number. The circuit is further configured to determine that the transaction is one of an on-us transaction or an off-us transaction. The circuit is further configured to authenticate the transaction information, in response to the transaction being an off-us transaction, by determining that the transaction information matches information stored in a third party authentication system and associated with the account number and the routing transit number by retrieving the information stored in the third party authentication system and comparing the transaction information with the retrieved information. The circuit is further configured to authenticate the transaction information by determining, in response to the transaction being an on-us transaction, that the transaction information matches the validated customer information stored in the customer database by comparing the transaction information to the validated customer information; and transmit a confirmation message to the originating computing device over the network via the network circuit in response to the transaction information being authenticated.

### BRIEF DESCRIPTION OF THE FIGURES

FIG. 1 is a block diagram illustrating a system for authenticating an account owner for an Automated Clearing House transaction, according to an example embodiment.

FIG. 2 is a flowchart of a method of authenticating an account owner with respect to an Automated Clearing House transaction information validation request, according to an example embodiment.

### DETAILED DESCRIPTION

Embodiments of systems and methods of authenticating an account owner for an Automated Clearing House (“ACH”) transaction are discussed herein. A financial institution computer system receives transaction information from an originating computing device (e.g., merchant computer system) that includes transaction information including information indicative of an account number, a name, and a routing transit number. The financial institution computer system determines that the transaction is one of an on-us transaction or an off-us transaction. In response to the transaction being off-us, the financial institution computer system authenticates the transaction information by determining whether the transaction information matches validated customer information stored in a third party authentication system and associated with the account number and routing transit number. In response to the transaction being on-us, the financial institution computer system authenticates the transaction information by determining whether the transaction information matches the validated customer information stored in a customer database maintained by the financial institution. The financial institution computer system transmits a confirmation message to the originating computing device over the network via the network circuit in response to the transaction information being authenticated. In some embodiments, the authentication system is provided by an originating depository financial institution (ODFI) via an application programming interface (API) that may be accessed by the originating computing device before the transaction is submitted to the ACH system for processing. In other embodiments, the authentication system is provided by a receiving depository financial institution (RDFI) via an application programming interface (API) that may be accessed by the originating computing device before the transaction is submitted to the ACH system for processing. In still further embodiments, the authentication system may be utilized after a transaction has been submitted for processing, e.g., an RDFI may perform an authentication analyses of a batch of ACH entries that have been received for processing. As such, a non-authorized user in possession of a routing transit number and an account number of an authorized user of an account at a financial institution is not able to make fraudulent transactions using the authorized user's account number and routing transit number.

For example, a customer wishing to make a purchase using a web-based online merchant or store may be presented with a screen to enter the customer's payment information. The payment screen may enable the customer to pay for the purchase using a variety of payment types, such as credit card, debit card, or using their checking account via an ACH system. Upon selecting the ACH transaction option, the customer is prompted to enter their name, routing transit number, and account number, though other information may also be provided. As disclosed herein, prior to transmitting the transaction requests via an ACH operator (i.e., one or more central clearing facilities through which financial institutions transmit or receive ACH entries, e.g., the Federal Reserve or the Electronic Payments Network) for posting to accounts of the receivers (e.g., the customer who is making the online payment), the inventive concepts of the present disclosure enable the web-based merchant to first send transaction information of ACH transaction requests to a financial instituting computing system to pre-validate other information provided in the ACH transaction request besides the routing transit number and the account number, such as the account holder's name. The financial institution computing system then conducts different pre-validation procedures depending on whether the transaction information is for an off-us or on-us transaction. For example, the if the transaction is for an off-us transaction, the financial institution computing system can check whether the account holder's name provided in the transaction information matches validated customer information stored in a third party authentication system (e.g., the Early Warning® System) and associated with the account number and routing transit number. In another example, if the transaction is for an on-us transaction, the financial institution computer system can check whether the account holder's name provided in the transaction information matches validated customer information stored in a customer account database of the financial institution computing system. Thereafter, the financial institution computing system returns a message to the originating computing device confirming whether or not the account holder's name provided in the transaction information matches the validated customer name. By pre-validating information provided by a customer using a web-based store to make a purchase, the financial institution computing system is able to provide the originating computer device with an indication of whether or not the transaction information contains an incorrect name, which can be indicative of an attempt by a fraudster to fraudulently make a purchase with someone else's payment information.

The embodiments and implementations of the systems and methods disclosed herein improve current transaction systems and computing systems for authenticating ACH payment transactions by authenticating additional transaction information in addition to an account number and routing transit number, such as an account owner name, telephone number, and address. These systems, methods, and computer implementations improve current ACH payment authentication systems by authenticating all information, or at least additional information than traditional systems, submitted in a transaction request in different ways depending on whether the transaction is an “on-us” transaction (i.e., where the receiver and originator both have accounts at the same financial institution) or an “off-us” transaction (i.e., where the receiver and originator accounts are at different financial institutions). At least one benefit of the improved ACH payment authentication system disclosed herein is that time and processing power for processing fraud claims submitted by authorized account owners is reduced or eliminated. Additionally, because a supplemental communication channel is provided (e.g., an API interface that may be accessed in real time, in addition to the traditional ACH network which operates in an overnight/batch processing configuration), potential fraud may be detected more quickly, potentially even before the customer is permitted to “check out” at the online retailer. In some embodiments, such an arrangements makes it possible to contact the account holder to whom the transaction will be debited, wherein such contact may incur in real time during the checkout process, instead of only later after batch processing of the ACH transaction has been completed. As such, the systems, methods, and computer implementations disclosed herein improve the functioning of transaction systems and computing systems for authenticating payment transactions by providing functionalities that are novel and non-obvious improvement over current systems.

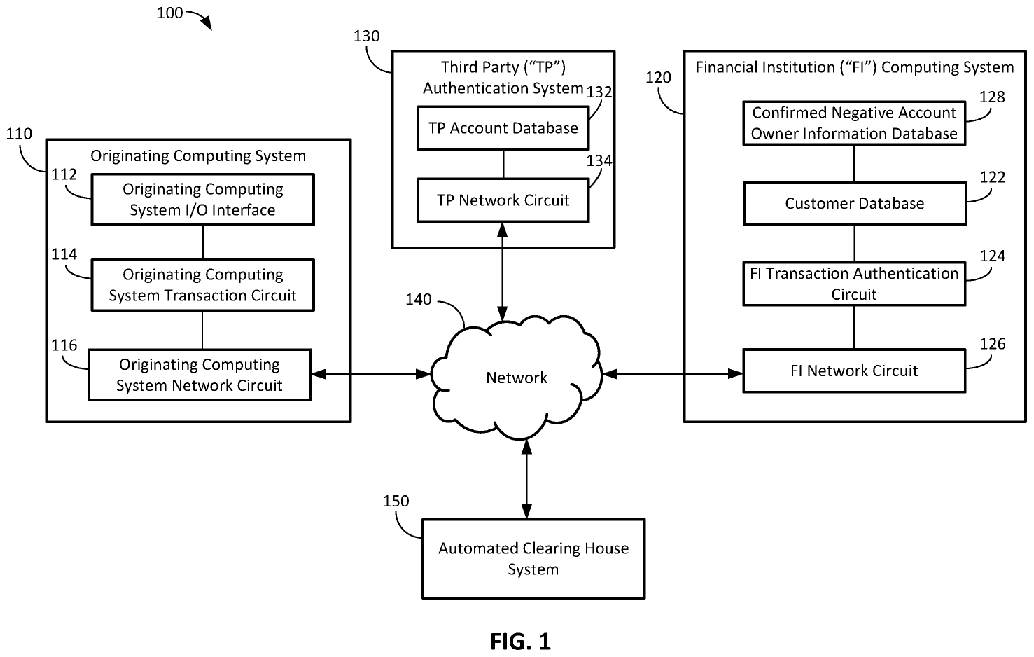

Referring to FIG. 1, a block diagram illustrating a system 100 for authenticating an account owner for an Automated Clearing House transaction is shown according to an example embodiment. The system 100 for authenticating an account owner for an Automated Clearing House transaction includes an originating computing system 110, a financial institution (“FI”) computing system 120, a third party authentication system 130, and an Automated Clearing House (“ACH”) system 150. Various components of the system 100 may be configured to communicate with each other over a network 140. The network 140 is a data exchange medium, which may include wireless networks (e.g., cellular networks, Bluetooth®, WiFi, Zigbee®), wired networks (e.g., Ethernet, DSL, cable, fiber-based), or a combination thereof. In some embodiments, the network 140 includes the internet.

The originating computing system 110 includes an originating computing system I/O interface 112, an originating computing system transaction circuit 114, and an originating computing system network circuit 116 enabling the originating computing system 110 to exchange data over the network 140.

The originating computing system 110 is a computing system associated with an individual or entity with whom a user seeks to transact (e.g., merchants, service providers). For example, the originating computing system 110 may include one or more servers or computers configured to process online transactions or one or more merchant point-of-sale terminals. The originating computing system 110 may be associated with a brick-and-mortar location that the user is able to physically visit in person to conduct a transaction, or an online store on a website. For example, the originating computing system 110 may be associated with a web-based merchant that enables a customer to conduct a transaction using a checking account by entering a routing transit number and an account number on a payment screen. The payment screen may also require or enable the customer to enter other information, such as the name on the checking account, a billing address or ZIP code, or birthday. In another example, the originating computing system 110 may be associated with a brick-and-mortar location that may require the customer to provide a check (e.g., a personal check) to an employee as payment for a good or service where the check includes a routing transit number, an account number, and a name, and where the employee at least one of inputs the routing transit number and account number from the check or scans an image of the check using the originating computing system I/O interface 112. In another example, the originating computing system I/O interface 112 of a brick-and-mortar store location can be configured to facilitate a mobile wallet payment made by a customer having a mobile device with a mobile wallet application. For example, the merchant may provide an application that is downloadable to the customer's mobile device, wherein the user can then enter a routing transit number and an account number into the application, and subsequently use the application to make payments at the brick and mortar store location. In this example, the I/O interface 112 is configured to receive payment information from the customer's mobile wallet application necessary to facilitate an ACH payment.

The originating computing system 110 is configured to receive transaction information from the user (e.g., such as routing transit number, account number, and user name) and to access an application programming interface provided by the FI computing system 120 (e.g., such as the FI network circuit 126) to provide the FI computing system 120 with a verification request including at least part of the transaction information (e.g., to check if the transaction information provided by the customer is valid). In some embodiments, the originating computing system 110 can receive transaction information from the user by the user inputting text into input fields (e.g., via a website interface or computer interface) or by directing a telephone operator to input their information. In some embodiments, the originating computer system 110 receives an output message from the FI computing system 120 indicating that the transaction information provided by the customer either one of matches verified customer data, does not match verified customer data, or is unknown whether the transaction information matches verified customer information.

After receiving the output message from the FI computing system 120, the originating computing system 110 communicates the transaction information provided by the customer to a financial institution (ODFI) associated with the originating computing system 110 as an ACH entry, which in turn batch processes the ACH entry along with other ACH entries at a later time (e.g., overnight) using a traditional ACH payment network (e.g., such as the ACH system 150).

The transaction information may include information received as part of a transaction request for the FI computing system 120 to withdraw a designated sum of funds from a financial account corresponding to the transaction information and deposit the designated sum of funds into an account associated with the originating party (e.g., an individual or entity associated with the originating computing system 110, such as a merchant). The transaction request may be a request for the FI computing system 120 to debit a financial account associated with the receiving party (e.g., the customer) and credit an account associated with the originating party (e.g., the merchant) in an amount specified by the transaction request.

The originating computing system I/O interface 112 includes hardware and associated logics configured to enable the originating computing system 110 to exchange information with a user and a terminal attendant (e.g., a store clerk, phone operator), if one is present or required. For example, the originating computing system I/O interface 112 of a brick-and-mortar location can be configured to facilitate a mobile wallet payment made by a customer having a mobile device with a mobile wallet application. In this example, the originating computing system I/O interface 112 is configured to receive payment information from the customer's mobile wallet application (e.g., such a mobile wallet application provided by the merchant, a financial institution, or other payment entity) necessary to facilitate an ACH payment, such as a routing transit number, an account number, and a name, among other possible information. An input aspect of the originating computing system I/O interface 112 allows the user to provide information to the originating computing system 110, and may include, for example, a mechanical keyboard, a touchscreen, a microphone, a camera, a fingerprint scanner, any user input device engageable to the originating computing system 110 via a USB, serial cable, Ethernet cable, and so on. An output aspect of the originating computing system I/O interface 112 allows the user to receive information from the originating computing system 110, and may include, for example, a digital display, a speaker, illuminating icons, LEDs, and so on. Further, the originating computing system I/O interface 112 may be configured to include assemblies that serve both input and output functions, allowing the FI computing system 120 and the originating computing system 110 to exchange information with the user. Such assemblies include, for example, radio frequency transceivers (e.g., RF or NFC-based transceivers) and other short range wireless transceivers (e.g., Bluetooth™, laser-based data transmitters).

The originating computing system transaction circuit 114 is configured to receive transaction information from the user via the originating computing system I/O interface 112, and assemble corresponding transaction requests (e.g., for processing via the ACH system 150) and transaction request information validation requests (e.g., for processing via the FI computing system 120). In some embodiments, the originating computing system transaction circuit 114 includes or is associated with computing systems configured to provide supplemental transaction information, for example product prices, inventory information, shipping or ordering information, and so on. In some embodiments, the originating computing system transaction circuit 114 determines an amount for a payment transaction and bundles the price with the transaction information to create a transaction request or a transaction information validation request. The originating computing system 110 then transmits the transaction information validation request to the FI computing system 120 to pre-validate the transaction information prior to submitting the transaction request as an ACH entry to the ACH system 150 for processing.

The ACH system 150 is configured to transmit funds from an Originator account to a Receiver account via an Originating Depository Financial Institution (“ODFI”) an ACH Network and a Receiving Depository Financial Institution (“RDFI”). The ACH Network is a nationwide batch-oriented electronic funds transfer system that provides for interbank clearing of electronic payments for participating depository financial institutions. An ACH entry can start with a receiver (e.g., a person or company having an account at the RDFI) authorizing an originator (e.g., a person or a company having an account at the ODFI) to issue ACH debit or credit to an account. Depending on the ACH transaction, the Originator must receive authorization from the Receiver. In accordance with the rules and regulations of ACH, no financial institution may issue an ACH transaction (whether it be debit or credit) towards an account without prior authorization from the Receiver. Once authorization is received, the originator can create an ACH entry to be provided to the ODFI, which can be any financial institution that is capable of doing ACH origination. The ACH entry is then sent to an ACH operator (i.e., one or more central clearing facilities through which financial institutions transmit or receive ACH entries, e.g., the Federal Reserve or the Electronic Payments Network) and is passed on to the RDFI, where the receiver's account is issued either a credit or debit, depending on the ACH transaction. The RDFI can reject the ACH transaction and return it to the ODFI with an appropriate reason, such as that there were insufficient funds in the account or that the account holder indicated that the transaction was unauthorized. An RDFI has a prescribed amount of time (measured from the receipt of the ACH transaction) in which to perform returns. An ODFI receiving a return of an ACH entry may re-present the ACH entry a predetermined number of times (e.g., two more times, or up to three total times) for settlement. The RDFI may reject the transaction again, after which the ODFI may no longer represent the transaction via ACH. As used in the example embodiments herein, the originating computing system 110 is associated with an originator. As used in the example embodiments herein, in some scenarios, the FI computing system 120 may be associated with the ODFI (e.g., where the API is provided by the ODFI for utilization by its customer/the originator). In other scenarios, the FI computing system 120 may be associated with the RDFI (e.g., where the disclosed arrangement is provided by a financial institution for its own use, or where the API is provided as a service for originators that will be submitting ACH transactions where the financial institution serves as RDFI). In still further scenarios, the FI computing system 120 may be associated with both the ODFI and the RDFI (e.g., in situations where both the originator and the receiver are customers of the financial institution). Other arrangements are also possible (e.g., the financial institution may be neither the ODFI nor the RDFI). Although specifically not shown in FIG. 1, when an ACH transaction is processed, at least one other financial institution computing system will be involved in processing the transaction (e.g., the computing system of the RDFI if the FI computing system 120 is the computing system of the ODFI, or the computing system of the ODFI if the FI computing system 120 is the computing system of the RDFI, etc.).

In a first example embodiment, the originator is a merchant with which a customer transacts, the ODFI is a bank that the merchant uses for processing payments and holding funds, the receiver is the customer that transacts with the merchant, and the RDFI is a bank that the customer uses for sending and receiving funds. In this embodiment, the ODFI and the RDFI are different banks (i.e., the transaction is “off-us”), and the FI computing system 120 may be a computing system of either one of the ODFI or the RDFI. When the FI computing system 120 is a computing system of the ODFI, the FI computing system 120 may not have access to contact information of the customer and therefore may not be able to directly contact the customer regarding a transaction initiated with their routing transit number and account number.

However, in such an arrangement, the FI computing system 120 can contact the customer through a third party. When the FI computing system 120 is a computing system of the RDFI, the FI computing system 120 has access to contact information of the customer and is able to communicate with the customer regarding transactions initiated using their routing transit number and account number (e.g., via an SMS text message to confirm whether the customer authorized the transaction). Accordingly, the FI computing system 120 may be capable of different functionalities depending on whether the transaction is an off-us transaction and based on which of the ODFI and RDFI includes the FI computing system 120. However, it will be appreciated that the FI computing system 120 is not limited to being in one of the ODFI or the RDFI, and may instead be part of a different financial institution. For example, where the FI computing system 120 is not part of one of the ODFI or the RDFI, the FI computing system 120 may be configured to communicate with at least one of the ODFI, the RDFI, and the originating computing system 120, and further configured to carry out the concepts disclosed herein remote from the ODFI, the RDFI, and the originating computing system 120.

In a second example, the ODFI and the RDFI are the same banks (i.e., the transaction is on-us), and this same bank includes the FI computing system 120. Otherwise, as in the first example, the originator is a merchant with which a customer transacts, the ODFI is a bank that the merchant uses for processing payments and holding funds, the receiver is the customer that transacts with the merchant, and the RDFI is the same as the ODFI and is a bank that the customer uses for sending and receiving funds. In this embodiment, the FI computing system 120 has access to customer information via the customer database 122, and may be configured to contact the customer regarding a transaction. When both the ODFI and the RDFI are the same bank that also includes the FI computing system 120, the FI computing system can settle a transaction request between a customer account and a merchant account held at the same bank without the transaction request being submitted to the ACH system 150 for processing.

Accordingly, as indicated herein, the different arrangements of merchant bank, customer bank, originating computing system 110, FI computing system 120, the ODFI, and the RDFI enable the concepts disclosed herein to be carried out and function, in some instance, differently from other arrangements of the these system components.

The FI computing system 120 includes a customer database 122, an FI transaction authentication circuit 124, an FI network circuit 126 enabling the FI computing system 120 to exchange data over the network 140, and a confirmed negative account owner information database 128. In some embodiments, the FI network circuit 126 communicates with a third party (e.g., such as a merchant, the originating computing system 110, and the third party authentication system 130) via a financial institution application programming interface.

The FI computing system 120 is a computing system at a financial institution that is capable of maintaining customer accounts (e.g., checking accounts) and databases of customer information. The financial institution may include commercial or private banks, credit unions, investment brokerages, or the like. In response to a received transaction information validation request, the FI computing system 120 may be configured to pre-validate the transaction information prior to the originating computing system 110 sending the transaction request as an ACH entry to the ACH system 150 for processing. The FI computing system 120 may be configured to transmit a message back to the originating computing system 110 indicating whether the transaction information provided by the customer either one of matches verified customer data, does not match verified customer data, or is unknown whether the transaction information matches verified customer information. In one example, where the transaction is an on-us transaction and the financial institution is both the ODFI and the RDFI, the FI computing system 120 may be configured to authorize the transaction between the originator and receiver and transfer funds between appropriate accounts.

The customer database 122 allows the FI computing system 120 to retrievably store customer information relating to the various operations discussed herein, and may include non-transient data storage mediums (e.g., local disc or flash-based hard drives, local network servers, and so on) or remote data storage facilities (e.g., cloud servers). The customer database 122 includes personal customer information (e.g., names, addresses, phone numbers), identification information (e.g., driver's license numbers, biometric data), and customer financial information (e.g., account numbers, account balances, available credit, credit history, transaction histories). The customer database 122 includes verified customer information relating to a plurality of users who are authorized to make transactions from a plurality of financial accounts (e.g., checking accounts, debit accounts, credit accounts). Authorized users may include account owners or other individuals designated as authorized users by a respective account owner.

The confirmed negative account owner information database 128 is configured to store transaction information for a plurality of transaction requests and a plurality of transaction information verification requests previously confirmed to have included incorrect transaction information. The incorrect transaction information may be information that was entered incorrectly (e.g., due to errors or misspellings), corrupted during transmission to the FI computing system 120, or purposely entered by a fraudster to conduct a fraudulent transaction not authorized by the account owner. For example, the FI computing system 120 can store transaction information (e.g., such as the name and account number combination) in the confirmed negative account owner information database 128 for transaction requests and transaction information validation requests that it determines to include transaction information (e.g., the name associated with the account number) not matching validated customer information (e.g., due to fraud, or simply incorrectly inputted transaction information). For example, the confirmed negative account owner information database 128 is configured to store known incorrect transaction information previously confirmed by the FI computing system 120 to not match valid transaction information.

The FI transaction authentication circuit 124 is configured to facilitate transactions by authenticating transaction information. For example, the FI transaction authentication circuit 124 can be configured to facilitate transactions using the ACH network. The FI transaction authentication circuit 124 can receive transaction information from the originating computing system 110 over the network 140 via the FI network circuit 126. The transaction information can be received by the FI transaction authentication circuit 124 via the FI network circuit 126 via a customizable application programming interface. In one embodiment, the FI transaction authentication circuit 124 authenticates the transaction information. In one embodiment, the FI transaction authentication circuit 124 looks up the information included in the transaction information in the customer database 122 and confirms whether the information is associated with an authorized account owner. In some embodiments, the FI transaction authentication circuit 124 may be configured to request additional authentication information from the user (e.g., a PIN, answers to one or more security questions).

The FI transaction authentication circuit 124 is configured to determine whether the transaction is an on-us transaction or an off-us transaction. For example, if the financial institution is the ODFI, then in response to determining that the transaction is an off-us transaction, the FI transaction authentication circuit 124 is configured to authenticate the transaction information by determining that the transaction information matches information stored in the third party authentication system 130 by retrieving the information stored in the third party authentication system 130 associated with the account number and comparing the transaction information with the retrieved information. Determining that the transaction is an off-us transaction may include determining that the receiver account is not an account maintained by the financial institution (i.e., that the financial institution is not both the RDFI and the ODFI).

Continuing with the scenario where the financial institution is the ODFI, then in response to determining that the transaction is an on-us transaction, the FI transaction authentication circuit 124 is configured to determine whether the transaction information matches the information stored in the customer database 122 by comparing the transaction information to the information stored in the customer database. Determining that the transaction is an on-us transaction can include determining that the financial institution is both the RDFI and the ODFI.

If the FI computing system 120 is at least the RDFI, the FI transaction authentication circuit 124 may be configured to prompt, in response to the transaction information not matching the information stored in the customer database 122, an authorized account owner to confirm that the transaction was authorized. Prompting the authorized account owner can include communicating a message to the authorized account owner requesting that the authorized account owner verify the authenticity of the transaction associated with the transaction information. Communicating the message to the authorized account owner can include at least one of telephoning the authorized account owner, conducting a video call with the authorized account owner, sending an email to the authorized account owner, and sending an SMS text message to the authorized account owner.

The FI transaction authentication circuit 124 is configured to authenticate the transaction information based on at least one of the transaction information matching the information stored in the customer database 122 or based on the authorized account owner confirming that the transaction was authorized.

The FI transaction authentication circuit 124 is configured to determine that the transaction information does not match the known incorrect transaction information previously confirmed to not match validated customer information stored in the confirmed negative account owner information database 128. If the transaction information does not match the known incorrect transaction information, the FI transaction authentication circuit 124 determines that the transaction information is not known to be invalid, or that it does not include information that the financial institution 120 knows to be used by a fraudster. If the transaction information matches the known incorrect transaction information, the FI transaction authentication circuit 124 determines that the transaction information is known to be invalid, and therefore outputs a message to the originating computing system 110 that the transaction information is not valid, which indicates that the transaction information provided by the customer includes incorrect information, which indicates that the customer or the merchant made a mistake inputting the transaction information, or that the customer or the merchant intentionally input incorrect information to defraud the true owner of the account number. By initially determining whether the transaction information matches or does not match the known incorrect transaction information, the FI transaction authentication circuit 124 can more quickly determine whether the transaction information is valid or not, and more quickly provide a response to the originating computing system 110, which saves processing time and processing power of the FI computing system 120.

In some embodiments, the transaction information is first transaction information of a plurality of transaction information validation requests comprising a batch, and the FI transaction authentication circuit 124 is configured to authenticate multiple sets of transaction information of the batch prior to the originating computing system 110 sending the batch of transaction requests as ACH entries to the ACH system 150 for processing. In some embodiments, the batch is processed at a specified time period, such as at the end of the day, or after a specified number of transaction requests have been accumulated by the originating computing system 110.

The transaction information includes information indicative of a variety of information necessary to process a transaction request, such as an account number and a routing transit number. The transaction information can further include additional verification information such as a name, an address, a ZIP code, a phone number, or other information (e.g., date of birth, a drivers' license number, etc.).

The FI transaction authentication circuit 124 is configured to transmit a confirmation message to the originating computing system 110 over the network via the network circuit in response to the transaction information being authenticated. The message can indicate whether the transaction information provided by the customer either one of matches verified customer data, does not match verified customer data, or is unknown whether the transaction information matches verified customer information. In some embodiments, the FI transaction authentication circuit 124 is configured to not transmit a message to the originating computing system 110. For example, the FI transaction authentication circuit 124 can store information relating to the transaction information in the customer database 122 instead, such as whether the name submitted with the transaction information matches a validated name associated with the customer account indicated in the transaction information.

In some embodiments, the FI transaction authentication circuit 124 determines that part of the transaction information is “unknown” to match validated customer information. For example, the FI transaction authentication circuit 124 can determine that it is unknown whether the transaction information, other than the account number and routing transit number, such as a name, matches verified account information. In some embodiments, the FI computing system 120 conducts additional fraud checks prior to transmitting a message to the originating computing system 110 indicating whether or not the transaction information provided by the customer either one of matches verified customer data, does not match verified customer data, or is unknown whether the transaction information matches verified customer information.

In some embodiments, the FI transaction authentication circuit 124 can perform a series of additional and separate checks. The FI transaction authentication circuit 124 may perform one or more fraud checks (e.g., comparing a location and time of a previous transaction with the location and time of the transaction of the specific transaction information). In addition, the FI transaction authentication circuit 124 may determine whether a transaction request associated with the transaction information may properly be completed (e.g., as part of an on-us transaction where the FI computing system 120 is both of the ODFI and RDFI), for example, by determining whether the account specified in the transaction information contains sufficient funds to cover a purchase price specified in the transaction information. In one embodiment, if a transaction request passes a plurality of fraud checks and the underlying transaction may properly be completed, the FI transaction authentication circuit 124 authorizes and completes the transaction request (e.g., as part of an on-us transaction where the financial institution is both the ODFI and the RDFI).

The third party (“TP”) authentication system 130 includes a TP account database 132 and a TP network circuit 134. The TP network circuit 134 is configured to enable the TP authentication system 130 to exchange data over the network 140.

The TP account database 132 can include verified account owner information aggregated from a plurality of financial institutions, including the financial institution associated with the FI computing system 120. In this way, many financial institutions can efficiently share account owner information with one another. Furthermore, the arrangement can be used by any financial institution to confirm whether details provided to it in a transaction request are valid and that the financial institution does not have a relationship with the financial institution of the transaction computing system 110, or with another financial institution to which funds of a customer are to be transferred as part of a transaction request. The TP authentication system 130 may be associated with the any entity that provides a system or service for authenticating an account owner.

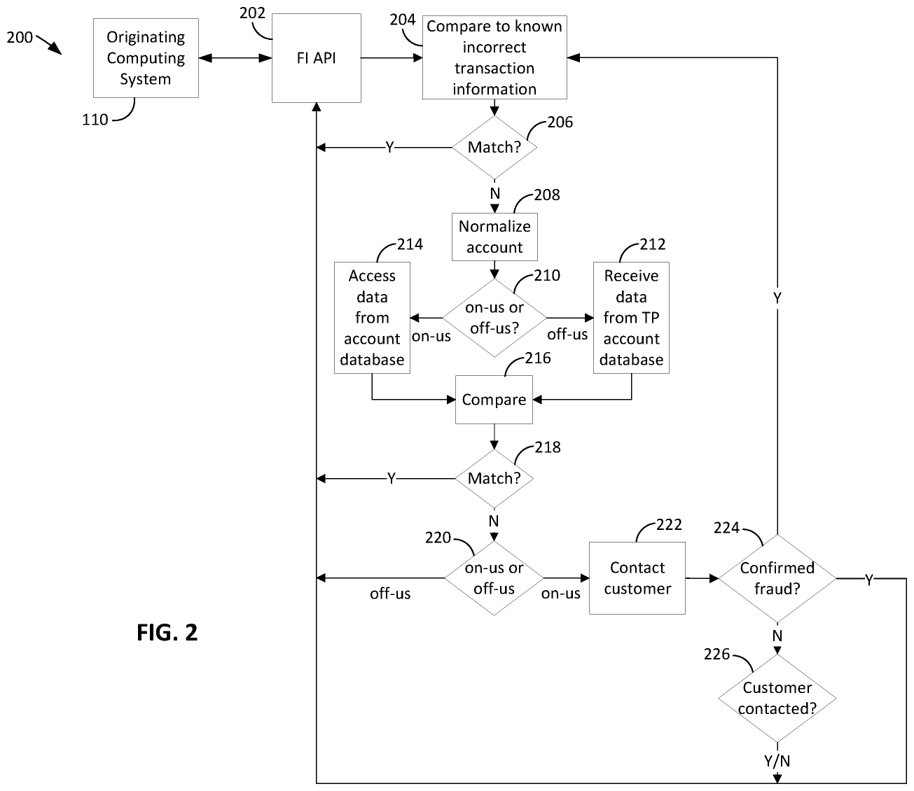

Referring now to FIG. 2, a flowchart of a method 200 of authenticating an account owner with respect to an Automated Clearing House transaction information validation request is shown according to an example embodiment. The method 200 may be performed by processing and storage hardware of a financial institution computing system (e.g., FI computing system 120), as executed by one or more logics comprising one or more software applications configured to perform the functions described herein.

At step 202, the FI computing system 120 receives transaction information. The transaction information can be received by the FI transaction authentication circuit 142 over the network 140 via the FI network circuit 126. The transaction information is received from an originating computing system, such as the originating computing system 110. The originating computing system can be associated with an entity or an individual. For example, the originating computing system may be associated with a brick-and-mortar retailer or an online retailor via an application or website interface. The transaction information includes information necessary to facilitate a transfer of funds from a specific account at the financial institution to the person or entity associated with the originating computing system. For example, the transaction information can include an account number and a routing transit number. In another example, the transaction information can also include additional verification information such as a name, an address, a ZIP code, a phone number, or other information (e.g., date of birth, a drivers' license number, etc.). In some embodiments, as shown in FIG. 2, the transaction information is received by the FI computing system 120 using an FI application programming interface (“API”). For example, transaction information received by a merchant entity via a website interface of the merchant can be provided to the FI computing system 120 from the merchant entity via the FI API.

At step 204, the FI computing system 120 determines if part of the transaction information is incorrect (e.g., such as the name) by comparing the transaction information to transaction information previously confirmed to have included incorrect transaction information. For example, the FI transaction authentication circuit 124 can compare the transaction information to information contained in a database of the FI computing system 120, such as the confirmed negative account owner information database 128. The confirmed negative account owner information database 128 stores transaction information for a plurality of transaction requests and a plurality of transaction information verification requests previously confirmed to have included incorrect transaction information. The incorrect transaction information may be information that was entered incorrectly (e.g., due to errors or misspellings), corrupted during transmission to the FI computing system 120, or purposely entered by a fraudster to conduct a fraudulent transaction not authorized by the account owner.

At step 206, the FI computing system 120 determines whether the transaction information matches transaction information previously confirmed to have included incorrect transaction information at step 204, and if so, the FI computing system 120 sends a communication to the originating computing system 120 indicating that the transaction information does not match information stored in the customer database 122 of the FI computing system 120.

If the FI computing system 120 determines that the transaction information does not match the transaction information previously confirmed to have included incorrect transaction information at step 204, the method 400 continues to step 208.

At step 208, the FI computing system 120 normalizes the account number and the routing transit number. As part of normalizing the account number and routing transit number, the FI computing system 120 determines if the account number and routing number are associated with the financial institution associated with the FI computing system 120 or if the numbers are associated with a different financial institution.

At step 210, the FI computing system 120 determines if the transaction is an “on-us” transaction or an “off-us” transaction. The FI computing system 120 determines if the transaction is “on-us” or “off-us” based on at least one of the routing number and the account number received in the transaction information and other information indicated by the transaction information (e.g., such as identification of a bank account for funds to be deposited into). The FI computing system 120 classifies a transaction as “on-us” when the originating financial institution, such as a financial institution of the originating computing system 110, and receiving financial institution, such as the financial institution associated with the FI computing system 120, are the same. The FI computing system 120 classifies a transaction as “off-us” when the originating financial institution and the receiving financial institution are different.

At step 212, if the FI computing system 120 determines that the transaction is off-us at step 210, then the FI computing system 120 receives data from a third party authentication system 130 (e.g., where the financial institution is the ODFI). The third party authentication system 130 may include TP account database 132. For example, the FI transaction authentication circuit 124 calls a process to retrieve authorized customer names associated with the account number provided in the transaction information from the TP account database 132 of the third party authentication system 130. In one alternative example, the FI computing system 120 sends the transaction information associated with the account number to the third party authentication system 130 for comparison by the third party authentication system 130, which then communicates back to the FI computing system 120 whether or not the transaction information matches information stored in the TP account database 132. The TP authentication system 130 may be associated with the any entity that provides a system or service for authenticating an account owner.

At step 214, if the FI computing system 120 determines that the transaction is on-us at step 210, then the FI computing system 120 receives data from a customer database of the FI computing system 120, such as the customer database 122. For example, the originator may be submitting transactions, and the financial institution may be operating as ODFI for all the submitted transactions, but some of the submitted transactions may be on-us and while others of the transactions may be off-us. For the on-us transactions, for example, the FI transaction authentication circuit 124 may call a process to retrieve authorized customer names associated with the account number provided in the transaction information from the customer database 122.

At step 216, the FI computing system 120 determines whether the transaction information matches the account information received from either the customer database 122 of the FI computing system 120 or the TP account database 132 of the third party authentication system 130. For example, the FI transaction authentication circuit 124 determines whether the name provided in the transaction information matches at least one authorized customer name associated with the account number provided in the transaction information and stored in the TP account database 132. In another example, the FI transaction authentication circuit 124 determines whether the name provided in the transaction information matches at least one authorized customer name associated with the account number provided in the transaction information and stored in the customer database 122. In some embodiments, the FI transaction authentication circuit 124 conducts a fuzzy logic match against the authorized customer name from the customer database 122 or the TP account database 132 with the name provided in the transaction information. In some embodiments, the FI computing system 120 determines whether the transaction information matches the account information retrieved or received from either one the customer database 122 of the FI computing system 120 or the TP account database 132 using a fuzzy match algorithm.

At step 218, if the FI computing system 120 determines that the name provided in the transaction information matches at least one authorized customer name associated with the account number provided in the transaction information and stored in the customer database 122 of the FI computing system 120 or the TP account database 132 of the third party authentication system 130 at step 216, then the FI computing system 120 sends a communication to the originating computing system 120 indicating that the transaction information provided in the transaction information matches at least one authorized customer name associated with the account number.

If the FI computing system 120 determines that the name provide in the transaction information does not match any authorized customer names associated with the account number provided in the transaction information and stored in the customer database 122 of the FI computing system 120 or the TP account database 132 of the third party authentication system 130 at step 216, then the method 400 continues to step 220.

At step 220, the FI computing system 120 determines if the transaction is on-us or off-us. If the FI computing system 120 determines that the transaction is off-us, then the FI computing system 120 determines that it is “unknown” whether the transaction information indicated by the transaction information, other than the account number and routing transit number, matches verified information associated with the account number (e.g., that a name of the transaction information matches a verified name associated with the account).

At step 222, if the FI computing system 120 determines that the transaction is on-us at step 220 where the financial institution is at least the RFDI, then an authorized customer associated with the account number indicated in the transaction information is contacted. For example, the FI computing system 120 can generate a prompt for someone to call the authorized customer to ask the authorized customer if a transaction associated with the transaction information is legitimate and was authorized by the authorized customer. In another example the FI computing system 120 can cause a text message, email, automated telephone operator, a social media message, or other form of communication to be sent to the authorized customer to query the customer whether a transaction associated with the transaction information is legitimate and was authorized by the authorized customer (e.g., made by the authorized customer or another person authorized to conduct a transaction using the routing transit number and account number).

At step 224, the authorized customer's response to the message is analyzed to determine if the transaction associated with the transaction information was not authorized by an authorized customer and is therefore fraudulent or if the transaction was authorized by an authorized customer of the account and is legitimate. If it is determined that the transaction associated with the transaction information is fraudulent, the FI computing system 120 sends a communication to the originating computing system 110 indicating that the transaction information does not match verified customer information. In some embodiments, the communication indicates that the transaction information does not match information stored in at least one of the customer database 122 or the TP account database 132. In some embodiments, if it is determined that the transaction information does not match verified customer information, the FI computing system 120 uses the transaction information in future applications of step 204. For example, the FI computing system 120 can store the transaction information (e.g., such as the name, routing transit number, and account number combination) in the confirmed negative account owner information database 128.

At step 226, if it is not determined whether the transaction information matches verified customer information at step 224, then the FI computing system 120 determines whether contact was made with the authorized customer at step 222. For example, if the FI computing system 120 determines that an authorized customer of the account was not successfully contacted, or did not respond to the customer contact initiated at step 222, the FI computing system 120 determines that it is “unknown” whether the transaction information, other than the account number and routing transit number, matches verified information associated with the account number (e.g., that a name submitted as part of the transaction information matches a verified name associated with the account).

If the FI computing system 120 determines that an authorized customer of the account was successfully contacted, and did respond to the customer contact initiated at step 222 to indicate that the transaction is legitimate, the FI computing system 120 sends a communication to the originating computing system 120 indicating that the transaction information matches at least one authorized customer name associated with the account number.

After FI computing system 120 sends a message to the originating computing system 110 indicating that the transaction information either one of matches verified customer data, does not match verified customer data, or is unknown whether the transaction information matches verified customer information, the originating computing system 110 can submit the transaction information for processing via the ACH system 150. For example, if the message indicates that the transaction information matches verified customer data, the originating computing system 110 submits the transaction information for processing via the ACH system 150. For example, if the message indicates that the transaction information does not match verified customer data, the originating computing system 110 does not submit the transaction information for processing via the ACH system 150. For example, if the message indicates that it is unknown whether the transaction information matches verified customer information, the originating computing system 110 can submit the transaction information for processing via the ACH system 150 if additional criteria is met. For example, in any of the above examples, the originating computing system 110 can conduct additional fraud checks on the transaction information as part of deciding whether or not to submit the transaction information for processing via the ACH system 150.

The embodiments described herein have been described with reference to drawings. The drawings illustrate certain details of specific embodiments that implement the systems, methods, and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein.

The circuit may be embodied as one or more circuitry components including, but not limited to, processing circuitry, network interfaces, peripheral devices, input devices, output devices, sensors, and so on. In some embodiments, a circuit may take the form of one or more analog circuits, electronic circuits (e.g., integrated circuits (IC), discrete circuits, system on a chip (SOCs) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, and so on. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), and so on. In some embodiments, the non-volatile media may take the form of ROM, flash memory (e.g., flash memory such as NAND, 3D NAND, NOR, 3D NOR), EEPROM, MRAM, magnetic storage, hard discs, optical discs, and so on. In other embodiments, the volatile storage media may take the form of RAM, TRAM, ZRAM, and so on. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input device,” as described herein, may include any type of input device or input devices including, but not limited to, a keyboard, a keypad, a mouse, joystick, or other input devices capable of performing a similar function. Comparatively, the term “output device,” as described herein, may include any type of output device or output devices including, but not limited to, a computer monitor, printer, facsimile machine, or other output devices capable of performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described to explain the principals of the disclosure and its practical application to enable one skilled in the art to utilize the various embodiments and with various modifications as are suited to the particular use contemplated. Other substitutions, modifications, changes, and omissions may be made in the design, operating conditions, and arrangement of the embodiments without departing from the scope of the present disclosure as expressed in the appended claims.

1. A financial institution computing system, the system comprising:
a network circuit configured to enable the financial institution computing system to exchange information with an originating computing device and an Automated Clearing House (ACH) system over a network, the originating computing device comprising a transaction circuit and an input/output interface including a radio frequency transceiver, a short-range wireless transceiver, at least one illuminating icon, and a digital display;
a customer database configured to store financial information and validated customer information for a plurality of customers of a financial institution; and
a transaction authentication circuit configured to:
receive, during a checkout process associated with a mobile wallet transaction over the network circuit via a customizable application programming interface (API), a transaction information validation request associated with a transaction request for the mobile wallet transaction from an application provided by the financial institution and wirelessly downloaded by a mobile device associated with a customer via a near field communication (NFC) communication with the radio frequency transceiver of the input/output interface of the originating computing device of the financial institution, the transaction information validation request comprising transaction information associated with the mobile wallet transaction bundled with supplemental transaction information, the transaction information including first transaction information indicative of an account number and a routing transit number and second transaction information indicative of a name, the supplemental transaction information indicative of a transaction amount, wherein the customizable API is configured to facilitate real-time communication during the checkout process between the transaction authentication circuit and the transaction circuit of the originating computing device and to receive at least a portion of the transaction information prior to the transaction circuit of the originating computing device submitting the transaction request to the ACH system over the network;
determine, during the checkout process and prior to submitting the transaction request, that the transaction information is for an ACH type transaction, wherein the financial institution computing system serves as both an Originating Depository Financial Institution and a Receiving Depository Financial Institution;
determine, during the checkout process, that the mobile wallet transaction associated with the transaction request is an on-us transaction by normalizing the transaction information to determine if the transaction information is associated with the financial institution computing system;
authenticate, during the checkout process and prior to the transaction circuit of the originating computing device submitting the transaction request to the ACH system and based on the determination that the mobile wallet transaction associated with the transaction request is an on-us transaction, the transaction request according to a first authentication procedure for on-us transactions from among the first authentication procedure and a second authentication procedure for off-us transactions;
determine, at a first time during the checkout process and according to the first authentication procedure, that the first transaction information and the second transaction information do not match information stored in a confirmed negative account owner information database of the financial institution computing system, the information in the confirmed negative account owner information database including information previously confirmed as not matching the validated customer information stored in the customer database;
receive, at a second time during the checkout process and according to the first authentication procedure, the validated customer information from the customer database in response to the determination that the first transaction information and the second transaction information do not match information stored in the confirmed negative account owner information database;
determine, according to the first authentication procedure during the checkout process, that the second transaction information does not match the received validated customer information by comparing the second transaction information to the validated customer information;
transmit, according to the first authentication procedure during the checkout process, based on the determination that the second transaction information does not match the received validated customer information, a communication to an authorized customer device, the communication including an authentication query;
receive, according to the first authentication procedure during the checkout process, in response to the communication to the authorized customer device, a response to the authentication query confirming the mobile wallet transaction is authorized by a user associated with the authorized customer device;
determine, according to the first authentication procedure during the checkout process, based on the response to the authentication query, that the mobile wallet transaction is legitimate;
authenticate, according to the first authentication procedure during the checkout process, the transaction information based on the determination that the mobile wallet transaction is legitimate;
provide, over the network circuit via the customizable API to the originating computing device during the checkout process, a confirmation message indicating that the transaction information is authenticated, the confirmation message configured to display, to the user via the at least one illuminating icon and the digital display, an indication that the transaction information is authenticated, the confirmation message further indicating that the transaction information has been pre-validated for the transaction request based on a determination that the transaction information matches validated transaction information stored in a third party (TP) authentication system, wherein the TP authentication system comprises a TP network circuit and an account database including information aggregated from a plurality of financial institutions;
transmit, to the application via the short-range wireless transceiver of the input/output interface of the originating computing device by a short-range wireless communication, a second confirmation message in response to the determination that the mobile wallet transaction is legitimate, the second confirmation message indicating that the transaction information has been authenticated;
provide, to the originating computing device subsequent to the checkout process, one or more indications that a subset of a plurality of ACH requests are pre-validated by the transaction authentication circuit of the financial institution computing system, the plurality of ACH requests including the transaction request, wherein the subset of the plurality of ACH requests comprises at least a specified number of pre-validated ACH requests; and
cause, subsequent to the checkout process, the transaction circuit of the originating computing device to submit the transaction request in a batch of authenticated ACH requests to the ACH system over the network based on (i) the indication that the transaction information matches the validated transaction information and (ii) the indication that the mobile wallet transaction is genuine and (iii) the determination that the subset of the plurality of ACH requests include at least the specified number of pre-validated ACH requests, wherein the batch of authenticated ACH requests is processed by the ACH system at a later time, and wherein the batch of authenticated ACH requests includes the subset of the plurality of ACH requests that have been pre-validated by the transaction authentication circuit of the financial institution computing system.

2. (canceled)

3. The financial institution computing system of claim 1, wherein the transaction authentication circuit is configured to authorize the transaction request associated with the transaction information, wherein authorizing the transaction request results in funds being transferred from a customer account to an account associated with the originating computing device.

4. (canceled)

5. The financial institution computing system of claim 1, wherein determining that the mobile wallet transaction is an on-us transaction comprises determining that the financial institution associated with the financial institution computing system is associated with a financial institution of an originator account identified by the transaction information.

6. The financial institution computing system of claim 1, wherein the transaction authentication circuit is configured to:
determine that the transaction information is genuine by comparing a location and time of a previous transaction with the location and time of the transaction information.

7. (canceled)

8. A financial institution computing system, the system comprising:
a network circuit configured to enable the financial institution computing system to exchange information with an originating computing device and an Automated Clearing House (ACH) system over a network, the originating computing device comprising a transaction circuit and an input/output interface including a radio frequency transceiver, a short-range wireless transceiver, at least one illuminating icon, and a digital display;
a customer database configured to store financial information and validated customer information for a plurality of customers of a financial institution; and
a transaction authentication circuit configured to:
receive, during a checkout process associated with a mobile wallet transaction over the network circuit via a customizable application programming interface (API), a transaction information validation request associated with a transaction request for the mobile wallet transaction from an application provided by the financial institution and wirelessly downloaded by a mobile device associated with a customer via a near field communication (NFC) communication with the radio frequency transceiver of the input/output interface of the originating computing device of the financial institution, the transaction information validation request comprising transaction information associated with the mobile wallet transaction bundled with supplemental transaction information, the transaction information including first transaction information indicative of an account number and a routing transit number, and second transaction information indicative of a name, the supplemental transaction information indicative of a transaction amount, wherein the customizable API is configured to facilitate real-time communication during the checkout process between the transaction authentication circuit and the transaction circuit of the originating computing device and to receive at least a portion of the transaction information prior to the transaction circuit of the originating computing device submitting the transaction request to the ACH system over the network;
determine, during the checkout process and prior to submitting the transaction request, that the transaction information is for an ACH type transaction, wherein the financial institution computing system serves as both an Originating Depository Financial Institution and a Receiving Depository Financial Institution;
determine, during the checkout process, that the mobile wallet transaction associated with the transaction request is an on-us transaction by normalizing the transaction information and determining that the transaction information is associated with the financial institution computing system;
authenticate, during the checkout process and prior to the transaction circuit of the originating computing device submitting the transaction request to the ACH system and based on the determination that the mobile wallet transaction associated with the transaction request is an on-us transaction, the transaction request according to a first authentication procedure for on-us transactions from among the first authentication procedure and a second authentication procedure for off-us transactions;
determine, at a first time during the checkout process and according to the first authentication procedure, that the first transaction information and the second transaction information do not match information stored in a confirmed negative account owner information database of the financial institution computing system, the information in the confirmed negative account owner information database including information previously confirmed as not matching the validated customer information stored in the customer database;
receive, at a second time during the checkout process and according to the first authentication procedure, the validated customer information from the customer database in response to the determination that the first transaction information and the second transaction information do not match information stored in the confirmed negative account owner information database;
determine, according to the first authentication procedure during the checkout process, that the second transaction information does not match the received validated customer information stored in the customer database by comparing the second transaction information to the validated customer information;
transmit, according to the first authentication procedure during the checkout process, based on the determination that the second transaction information does not match the received validated customer information, a communication to an authorized customer device, the communication including an authentication query;
receive, according to the first authentication procedure during the checkout process, in response to the communication to the authorized customer device, a response to the authentication query confirming that the mobile wallet transaction is authorized by a user associated with the authorized customer device;
determine, according to the first authentication procedure during the checkout process, based on the response to the authentication query, that the mobile wallet transaction is legitimate;
authenticate, according to the first authentication procedure during the checkout process, the transaction information based on the determination that the mobile wallet transaction is legitimate;
provide, over the network circuit via the customizable API to the originating computing device during the checkout process, a confirmation message indicating that the transaction information is authenticated, the confirmation message configured to display, to the user via the at least one illuminating icon and the digital display, an indication that the transaction information is authenticated, the confirmation message further indicating that the transaction information has been pre-validated for the transaction request based on a determination that the transaction information matches validated transaction information stored in a third party (TP) authentication system, wherein the TP authentication system comprises a TP network circuit and an account database including information aggregated from a plurality of financial institutions;
transmit, to the application via the short-range wireless transceiver of the input/output interface of the originating computing device by a short-range wireless communication, a second confirmation message in response to the determination that the mobile wallet transaction is legitimate, the second confirmation message indicating that the transaction information has been authenticated; and
provide, to the originating computing device subsequent to the checkout process, one or more indications that a subset of a plurality of ACH requests are pre-validated by the transaction authentication circuit of the financial institution computing system, the plurality of ACH requests including the transaction request, wherein the subset of the plurality of ACH requests comprises at least a specified number of pre-validated ACH requests.

9. The financial institution computing system of claim 8, wherein the transaction authentication circuit is configured to cause, subsequent to the checkout process, the transaction circuit of the originating computing device to submit the transaction request in a batch of authenticated ACH requests to the ACH system over the network based on (i) the indication that the transaction information matches the validated transaction information and (ii) the indication that the mobile wallet transaction is genuine and (iii) the determination that the subset of the plurality of ACH requests include at least the specified number of pre-validated ACH requests, wherein the batch of authenticated ACH requests is processed by the ACH system at a later time, and wherein the batch of authenticated ACH requests includes the subset of the plurality of ACH requests that have been pre-validated by the transaction authentication circuit of the financial institution computing system.

10. The financial institution computing system of claim 8, wherein the transaction authentication circuit is configured to authorize the transaction request associated with the transaction information, wherein authorizing the transaction request results in funds being transferred from a customer account to an account associated with the originating computing device.

11. (canceled)

12. The financial institution computing system of claim 8, wherein determining that the mobile wallet transaction is an on-us transaction comprises determining that the financial institution associated with the financial institution computing system is the same as a financial institution of an originator account identified by the transaction information.

13. The financial institution computing system of claim 8, wherein the transaction authentication circuit is configured to:
determine that the transaction information is genuine by comparing a location and time of a previous transaction with the location and time of the transaction information.

14. (canceled)

15. A financial institution computing system, the system comprising:
a network circuit configured to enable the financial institution computing system to exchange information with an originating computing device and an Automated Clearing House (ACH) system over a network, the originating computing device comprising a transaction circuit and an input/output interface including a radio frequency transceiver, a short-range wireless transceiver, at least one illuminating icon, and a digital display;
a customer database configured to store financial information and validated customer information for a plurality of customers of a financial institution; and
a transaction authentication circuit configured to:
receive, during a checkout process associated with a mobile wallet transaction over the network by the network circuit via a customizable application programming interface (API), a transaction information validation request associated with a transaction request for the mobile wallet transaction from an application provided by the financial institution and wirelessly downloaded by a mobile device associated with a customer via a near field communication (NEC) communication with the radio frequency transceiver of the input/output interface of the originating computing device of the financial institution, the transaction information validation request comprising transaction information associated with the mobile wallet transaction bundled with supplemental transaction information, the transaction information including first transaction information indicative of an account number and a routing transit number, and second transaction information indicative of a name, the supplemental transaction information indicative of a transaction amount, wherein the customizable API is configured to facilitate real-time communication during the checkout process between the transaction authentication circuit and the transaction circuit of the originating computing device and to receive at least a portion of the transaction information prior to the transaction circuit of the originating computing device submitting the transaction request to the ACH system over the network;
determine, during the checkout process and prior to submitting the transaction request, that the transaction information is for an ACH type transaction, wherein the financial institution computing system serves as both an Originating Depository Financial Institution and a Receiving Depository Financial Institution;
determine, during the checkout process, that the mobile wallet transaction associated with the transaction request is one of an on-us transaction or an off-us transaction by normalizing the transaction information to determine whether the transaction information is associated with the financial institution computing system, wherein the transaction information is associated with the financial institution computing system for on-us transactions, and is associated with a different institution for off-us transactions;
authenticate, during the checkout process and prior to the transaction circuit of the originating computing device submitting the transaction request and in response to the mobile wallet transaction being an on-us transaction, the transaction information according to a first authentication procedure for on-us transactions from among the first authentication procedure for on-us transactions and a second authentication procedure for off-us transactions, the first authentication procedure including determining that the second transaction information does not match the validated customer information stored in the customer database by receiving the validated customer information from the customer database and comparing the transaction information to the received validated customer information;
determine, according to the first authentication procedure during the checkout process, that the first transaction information and the second transaction information do not match information stored in a confirmed negative account owner information database of the financial institution computing system, the information in the confirmed negative account owner information database including information previously confirmed as not matching the validated customer information stored in the customer database;
transmit, according to the first authentication procedure during the checkout process and based on the determination that the second transaction information does not match the received validated customer information, a communication to an authorized customer device, the communication including an authentication query;
receive, according to the first authentication procedure during the checkout process and in response to the communication to the authorized customer device, a response to the authentication query confirming the mobile wallet transaction is authorized by a user associated with the authorized customer device;
determine, according to the first authentication procedure during the checkout process and based on the response to the authentication query, that the mobile wallet transaction is legitimate;
authenticate, according to the first authentication procedure during the checkout process, the transaction information based on the determination that the mobile wallet transaction is legitimate;
provide, over the network circuit via the customizable API to the originating computing device during the checkout process, a confirmation message indicating that the transaction information is authenticated, the confirmation message configured to display, to the user via the at least one illuminating icon and the digital display, an indication that the transaction information is authenticated, the confirmation message further indicating that the transaction information has been pre-validated for the transaction request based on a determination that the transaction information matches validated transaction information stored in a third party (TP) authentication system, wherein the TP authentication system comprises a TP network circuit and an account database including information aggregated from a plurality of financial institutions;
transmit, to the application via the short-range wireless transceiver of the input/output interface of the originating computing device by a short-range wireless communication, a second confirmation message in response to the transaction information being authenticated;
provide, to the originating computing device subsequent to the checkout process, one or more indications that a subset of a plurality of ACH requests are pre-validated by the transaction authentication circuit of the financial institution computing system, the plurality of ACH requests including the transaction request, wherein the subset of the plurality of ACH requests comprises at least a specified number of pre-validated ACH requests; and
cause, subsequent to the checkout process, the transaction circuit of the originating computing device to submit the transaction request in a batch of authenticated ACH requests to the ACH system over the network based on (i) the indication that the transaction information matches the validated transaction information and (ii) the indication that the mobile wallet transaction is genuine and (iii) the determination that the subset of the plurality of ACH requests include at least the specified number of pre-validated ACH requests, wherein the batch of authenticated ACH requests is processed by the ACH system at a later time, and wherein the batch of authenticated ACH requests includes the subset of the plurality of ACH requests that have been pre-validated by the transaction authentication circuit of the financial institution computing system.

16. The financial institution computing system of claim 15, wherein the communication is one of a text message, email, automated telephone operator, or social media message, and wherein the response to the authentication query includes confirmation that the mobile wallet transaction is not fraudulent.

17. (canceled)

18. (canceled)

19. The financial institution computing system of claim 15, wherein the transaction authentication circuit is configured to:
determine that the transaction information is genuine by comparing a location and time of a previous transaction with the location and time of the transaction information.

20. (canceled)

21. An originating computing system, comprising:
a network circuit configured to enable the originating computing system to exchange information over a network with an Automated Clearing House (ACH) system and a Financial Institution (FI) computing system;
an input/output interface comprising a radio frequency transceiver, a short-range wireless transceiver, at least one illuminating icon, and a digital display; and
one or more processors coupled to one or more memory devices storing instructions that, when executed by the one or more processors, cause the one or more processors to:
provide, via the network circuit, a mobile application to a mobile device of a customer;
receive, from the mobile application via the radio frequency transceiver of the input/output interface by a near field communication (NFC) communication during a checkout process associated with a mobile wallet transaction, transaction information associated with a transaction request for the mobile wallet transaction, the transaction information including a transaction time, a transaction location, first transaction information indicative of an account number, and a routing transit number and second transaction information indicative of a name, wherein the mobile wallet transaction is an ACH transaction;
receive, from a computing system during the checkout process, supplemental transaction information associated with the transaction request;
create, during the checkout process and based on the received transaction information associated with the transaction request and the supplemental transaction information, a transaction information validation request, the transaction information validation request comprising the transaction information associated with the transaction request and the supplemental transaction information;
provide, by a first communication channel via a customizable application programming interface (API) during the checkout process, a plurality of validation requests to the FI computing system, the customizable API configured to facilitate real time communication between the originating computing system and the FI computing system, the plurality of validation requests including the transaction information validation request, the transaction information validation request provided to the FI computing system for pre-validation of the mobile wallet transaction prior to the originating computing system submitting the transaction request to an ACH system over the network, wherein the plurality of validation requests are associated with a plurality of ACH requests including the transaction request;
receive, by the first communication channel from the FI computing system during the checkout process, an indication that the mobile wallet transaction is genuine based on a comparison of a previous transaction time and a previous transaction location of a previous transaction with the transaction time and the transaction location of the transaction information;
receive, by the first communication channel from the FI computing system during the checkout process, a confirmation message indicating that the transaction information is authenticated, the confirmation message indicating the transaction information has been pre-validated for the transaction request based on a determination that the transaction information matches validated transaction information stored in a third party (TP) authentication system, wherein the TP authentication system comprises a TP network circuit and an account database including information aggregated from a plurality of financial institutions;
display, via the at least one illuminating icon and the digital display of the input/output interface during the checkout process, an indication that the transaction information is authenticated; and
provide, to the mobile application via the short-range wireless transceiver of the of the input/output interface by a short-range wireless communication during the checkout process, the confirmation message;
receiving, from the FI computing system subsequent to the checkout process, one or more indications that a subset of the plurality of ACH requests are pre-validated by the FI computing system;
determine, subsequent to the checkout process, that the subset of the plurality of validation requests include at least a specified number of pre-validated ACH requests;
submit, to the ACH system subsequent to the checkout process and by a second communication channel via the input/output interface based on (i) the indication that the transaction information matches the validated transaction information and (ii) the indication that the mobile wallet transaction is genuine and (iii) the determination that the subset of the plurality of ACH requests include at least the specified number of pre-validated ACH requests, the transaction request and the subset of the plurality of ACH requests in a batch of pre-validated ACH requests to complete the mobile wallet transaction based on the transaction request, wherein the batch of pre-validated ACH requests is processed by the network at a later time.
